(19) United States
(12) Patent Application Publication
(10) Pub. No.: US 2012/0027417 A1
(43) Pub. Date: Feb. 2, 2012

(54) OPTICAL POWER DIVIDER

(76) Inventors: Charles M. SANTORI, Palo Alto, CA (US); Michael Renne Ty Tan, Menlo Park, CA (US); Jingjing Li, Palo Alto, CA (US)

(21) Appl. No.: 12/847,444

(22) Filed: Jul. 30, 2010

(51) Int. Cl. H04B 10/12; H04B 10/02; G02B 27/12

(52) U.S. Cl. 398/141; 359/626; 398/153

(57) ABSTRACT

An optical power divider includes a body having a first side and a second side. The first side includes at least one cylindrical input lens and the second side includes an array of output lenses. The at least one cylindrical input lens is configured to expand input light along a first axis to be directed to a plurality of the output lenses arranged along the first axis and the output lenses are configured to focus the light received from the input lenses into respective output beams of light.

### BACKGROUND

Fiber optic transmission of data offers many advantages over more traditional forms of data transmission between electronic devices. For instance, optical signals are generally immune to errors caused by electromagnetic interference, and systems utilizing the optical signals are typically less prone to sparking and short circuiting. The use of fiber optic transmission also eliminates ground loop problems by providing electrical isolation between optically linked equipment.

Fiber optic transmission systems is often employed in distributed processing systems, such as, in a local area network, in a data bus system, between various servers, and the like. These systems typically require the use of processors or terminals to communicate data with each other as well as with other peripheral devices. In this regard, conventional fiber optic transmission systems often use a ring or a star type architecture to enable the data communication among a plurality of electronic devices.

### BRIEF DESCRIPTION OF THE DRAWINGS

Embodiments are illustrated by way of example and not limited in the following figure(s), in which like numerals indicate like elements, in which:

FIG. 1 depicts a perspective view of a data communication system including an optical power divider, according to an embodiment of the invention;

FIG. 2 shows a schematic diagram of a data communication system, according to an embodiment of the invention; and

FIG. 3 shows a schematic diagram of a data communication system, according to another embodiment of the invention.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures are not described in detail so as not to unnecessarily obscure the description of the embodiments.

Disclosed herein are embodiments directed to an optical power divider and a fiber optic communication system that employs the optical power divider. The optical power divider disclosed herein comprises cylindrical input lenses that receive input light beams and expand the light beams along respective single axes through the optical power divider. Here the term ‘cylindrical’ lens refers to any curved surface that varies along one direction only; for example the cross-section could be circular or hyperbolic. In this regard, the received input light is spread along one axis according to the divergence angle of the source of the light beams, without substantially spreading along other axes, which substantially maximizes the intensities of the light beams. The optical power divider disclosed herein also includes output lenses that vary along two axes, for instance, the output lenses may have spherical or aspheric surfaces and may be positioned along the respective axes of light beam expansion, in which the output lenses are configured to focus the expanded light beams into multiple beams of output light.

A relatively large number of output lenses may be provided on the optical power divider to thus enable the input light beams to be split into a relatively large number of output beams. For instance, a sufficient number of output lenses may be provided to extend across most of the width of an optical power divider such that greater than 90% of the input light is outputted through the output lenses. In this regard, most of the received light may be passed through the optical power divider, which results in substantially maximized output light beam strengths.

The optical power divider disclosed herein may be fabricated from a single plastic component into which the cylindrical input lenses and the spherical or aspheric output lenses are formed. Thus, for instance, the optical power dividers disclosed herein may be formed through a relatively simple and inexpensive molding process.

The optical power divider disclosed herein may be employed in a fiber optic data communication system through which data is communicated among a plurality of electronic devices. In one example, the optical power divider may be operated as a star coupler between a plurality of the electronic devices.

In the following description, the term “light” refers to electromagnetic radiation with wavelengths in the visible and non-visible portions of the electromagnetic spectrum, including infrared and ultra-violet portions of the electromagnetic spectrum.

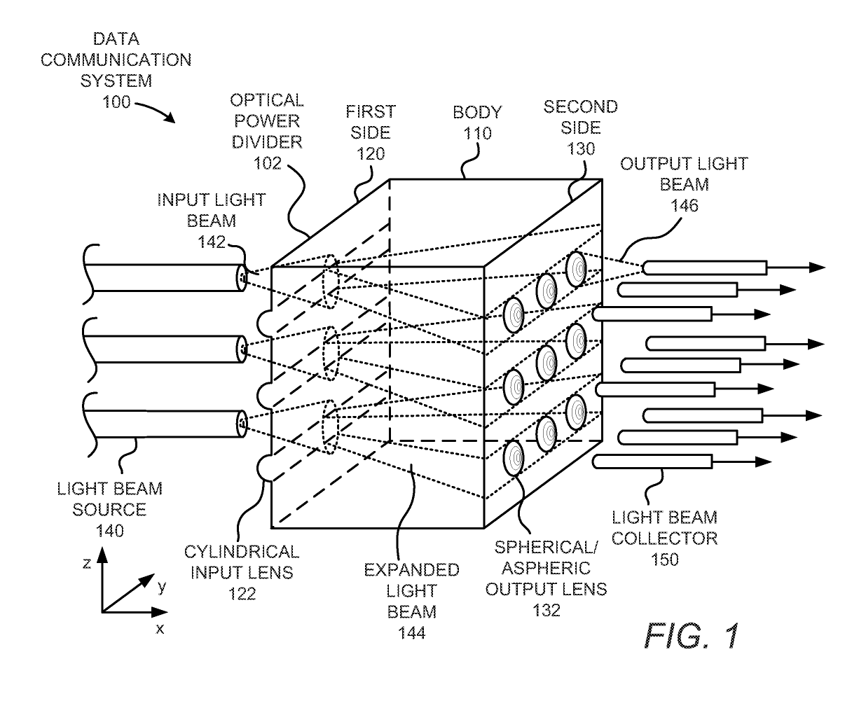

With reference first to FIG. 1, there is shown a perspective view of a data communication system 100 including an optical power divider 102, according to an embodiment of the present invention. It should be understood that the data communication system 100 depicted in FIG. 1 may include additional components and that some of the features described herein may be removed and/or modified without departing from a scope of the data communication system 100.

As depicted in FIG. 1, the data communication system 100 includes an optical power divider 102, a plurality of light beam sources 140, and a plurality of light beam collectors 150. The optical power divider 102 is depicted as being positioned between the light beam sources 140 and the light beam collectors 150. In addition, the optical power divider 102 is depicted as receiving input light beams 142 from the light beam sources 140 and outputting a larger number of output light beams 146 to the light beam collectors 150. In FIG. 1, a single output light beam 146 has been depicted and identified for purposes of clarity.

The optical power divider 102 is depicted as having a generally rectangular or square shaped, three-dimensional body 110. It should, however, be clearly understood that the body 110 may have any other suitable three dimensional shape. In any regard, the optical power divider 102 is depicted as including a first side 120 that faces toward the light sources 140 and a second side 130 that faces toward the light beam collectors 150. The first side 120 has also been depicted as including a plurality of cylindrical input lenses 122 that extend across a width of the first side 120, along a y-axis. The cylindrical input lenses 122 have also been depicted as being spaced apart from each other along the z-axis to receive input light beams 142 from respective light beam sources 140. The second side 130 includes a plurality of spherical or aspheric output lenses 132 that are positioned across the width of the second side 130, along the y-axis.

As further shown in FIG. 1, the cylindrical input lenses 122 are configured to expand the input light beams 142 along a first axis, in this case, the y-axis. The expanded light beams 144 are depicted as the dashed lines extending through the body 110 between the cylindrical input lenses 122 and the spherical/aspheric output lenses 132. More particularly, each of the cylindrical input lenses 122 collimates a respective input light beam 142 with respect to the z-axis, but allows the input light beam 142 to expand across a relatively wide area along a single axis (y-axis) to be directed to a respective group of the spherical or aspheric output lenses 132. The group of the output lenses 132 for a particular cylindrical input lens 122 comprises those output lenses 132 that are arranged along the single axis along which the cylindrical input lens 122 allows the light beams 144 to expand. Thus, in the example depicted in FIG. 1, the uppermost group of spherical/aspheric output lenses 132 that extend along the y-axis receive light that has been allowed to expand by the uppermost cylindrical input lens 122, and so forth.

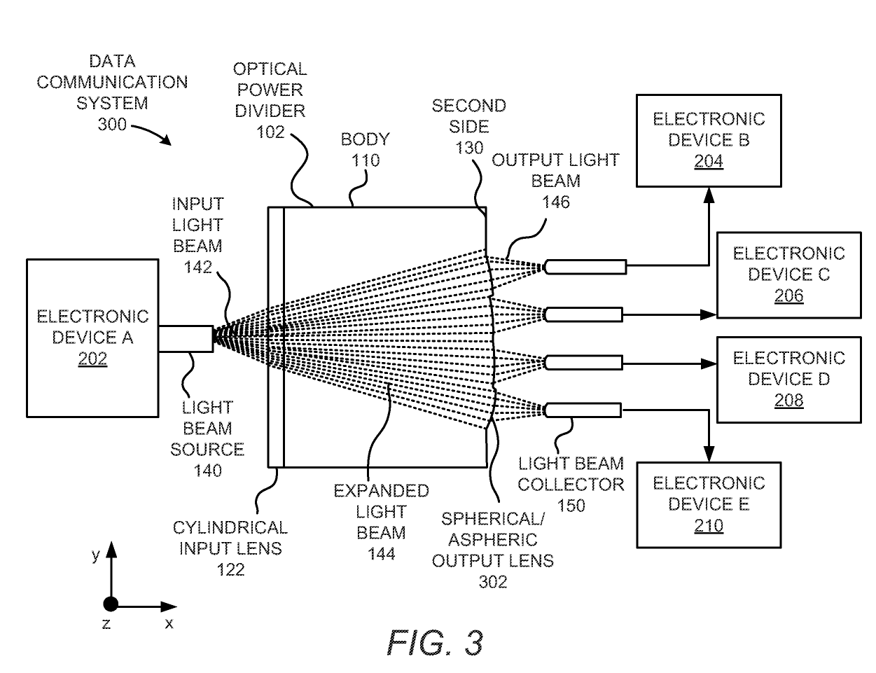

The expansion of the input light beams 142 may be restricted to a single axis to substantially maximize the intensities of the light beams emitted and expanded through the body 110 of the optical power divider 102. In one possible configuration, each of the cylindrical lenses 122 may have a hyperbolic cross section designed such that light originating from a particular point at the light beam source (140) will be perfectly collimated with respect to the z-axis. In addition, the second side 130 of the body 110 may include groups of spherical or aspheric output lenses 132 that extend substantially across the width of the body 110 to substantially maximize the number of output light beams 146 originating from each of the cylindrical input lenses 122. Thus, although the output lenses 132 in each group have been depicted as being relatively spaced apart from each other, it should be clearly understood that the output lenses 132 may be positioned to be substantially adjacent to each other and to substantially fill the space along the y-axis of the second side 130, for instance, as shown in FIG. 3.

In addition, the boundaries of the output lenses 132 need not be circular as depicted in the FIG. 1, but rather, may be rectangular or square, such that the output lenses 132 cover substantially all of the illuminated surface area of the second side 130. Moreover, the output lenses 132 may be substantially evenly spaced along the y axis, or the output lenses 132 may be unevenly spaced to substantially equalize the total power sent to each light beam collector 150, taking into account the distribution of ray angles produced by a particular light beam source 140. Furthermore, the curved surfaces of the output lenses 132 may be aspheric and may thus be designed such that light originating from a single point at the source 140 is imaged as perfectly as possible to a set of points at the light beam collectors 150. The aspheric surface may be defined by a mathematical function f(y,z) that has different curvatures with respect to y and z in order to achieve a substantially optimized focus onto the light beam collectors 150. By using aspheric surfaces, acceptable imaging performance may be achieved in a relatively compact device. In addition, the aspheric surfaces may be formed in a relatively easy manner onto the second side 130 without requiring relatively expensive manufacturing costs, for instance, when the optical power divider 102 is molded from plastic.

In one example, the cylindrical input lenses 122 and the spherical or aspheric output lenses 132 are configured to cause substantially all of the input light beams 142, except for light emerging from the light beam sources 140 at too steep of an angle to reach the output lenses 132, to reach the light beam collectors 150.

The body 110 of the optical power divider 102 is formed of a transparent material to substantially minimize intensity loss of the light beams through the body 110. By way of example, the body 110 comprises a plastic material, a glass material, a combination of plastic and glass materials, and the like. In one embodiment, the body 110 is molded to include the cylindrical input lenses 122 and the spherical/aspheric output lenses 132. In another embodiment, the cylindrical input lenses 122 and the spherical/aspheric output lenses 132 are formed on the body 110 by, for instance, diamond turning, etching, carving, milling, photolithography, melting and reflow, etc.

The light beam sources 140 may comprise any suitable devices through which light beams may be supplied to the optical power divider 102. By way of example, the light beam sources 140 comprise multimode fibers, single-mode fibers, vertical-cavity surface-emitting lasers, hollow waveguides, optical waveguides, etc. In addition, the light beam collectors 150 may comprise any suitable devices through which light beams may be collected and transmitted. By way of example, the light beam collectors 150 comprise multimode fibers, optical waveguides, etc.

Although not shown, the positions of the light beam sources 140 and the light beam collectors 150 may be substantially maintained with respect to the optical power divider 102 in any suitable manner that does not interfere with the transmission of the input light beams 142 or the output light beams 146. Thus, for instance, the positions of the light beam sources 140 and the light beam collectors 150 may substantially be maintained through use of mechanical components, such as, brackets, or other components. As another example, the light beam sources 140 and the light beam collectors 150 may be attached to the optical power divider 102 through use of adhesives.

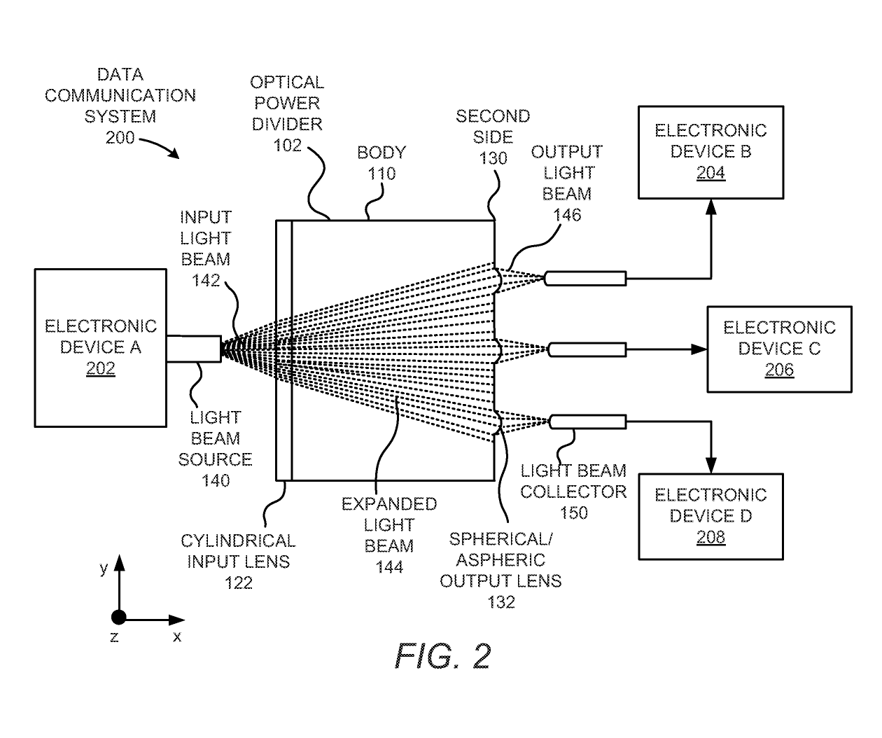

With reference now to FIG. 2, there is shown a schematic diagram of a data communication system 200 and a cross-sectional side view of the optical power divider 102, according to an example of the invention. It should be understood that the data communication system 200 depicted in FIG. 2 may include additional components and that some of the features described herein may be removed and/or modified without departing from a scope of the data communication system 200.

The data communication system 200 depicted in FIG. 2 includes all of the same features as the data communication system 100 depicted in FIG. 1. FIG. 2 differs from FIG. 1, however, in that a cross-sectional top view of the optical power divider 102 is depicted in FIG. 2. In addition, an electronic device A has been depicted as being connected to the light beam source 140 and a plurality of electronic devices B-D 204-208 have been depicted as being connected to respective ones of the light beam collectors 150. Although not shown, additional electronic devices may be positioned beneath the electronic device 202 along the z-axis to provide input light beams 142 into the optical power divider 102.

As shown in FIG. 2, the data communication system 200 enables data to be communicated from the electronic device A 202 to the other electronic devices B-D 204-208. More particularly, the optical power divider 102 enables data to be simultaneously broadcasted to each of the electronic devices B-D 204-208. The optical power divider 102 may thus operate as a star coupler. The electronic devices B-D 204-208 may also be configured to communicate data to other ones of the electronic devices 202-208 through other similar optical power dividers 110. In any regard, the electronic devices A-D 202-208 may comprise any of a plurality of different types of electronic devices configured to communicate and receive data through optical signals. For instance, the electronic device 202-208 may comprise servers, CPUs, circuit boards, etc.

As shown in FIG. 2, an input light beam 142 is generated by the electronic device 202 and is inputted into the cylindrical input lens 122 through the light beam source 140. The cylindrical input lens 122 expands the input light beam 142, such that the expanded light beam 144 is expanded to illuminate a plurality of spherical or aspheric output lenses 132. In addition, the spherical output lenses 132 that receive the expanded light beam 144 focus the received light into respective output beams of light 146, which are directed to respective light beam collectors 150. The output light beams are transmitted through the light beam collectors 150 to respective electronic devices B-D 204-208. In this regard, data from the electronic device A 202 may be communicated to each of the other electronic devices A-D 204-208 through transmission of optical signals through the optical power divider 102.

Turning now to FIG. 3, there is shown a schematic diagram of a data communication system 300 and a cross-sectional side view of the optical power divider 102, according to another example of the invention. It should be understood that the data communication system 300 depicted in FIG. 3 may include additional components and that some of the features described herein may be removed and/or modified without departing from a scope of the data communication system 300.

The data communication system 300 depicted in FIG. 3 includes all of the same features as the data communication system 200 depicted in FIG. 2, except for the configuration of the spherical/aspheric output lens 132 of the optical power divider 102 and the addition of another electronic device 210. As shown in FIG. 3, the second side 130 is depicted as including a plurality of spherical/aspheric output lenses 302. The spherical/aspheric output lenses 302 differ from the spherical/aspheric output lenses 132 depicted in FIGS. 1 and 2 in that the spherical/aspheric output lenses 302 are configured to cause a greater amount of light in the body 110 to be outputted to the electronic devices 204-210. In this regard, the spherical/aspheric output lenses 132 are arranged along the second side 130 with respect to each other to substantially reduce or eliminate gaps between the spherical/aspheric lenses 132. As such, the spherical/aspheric output lenses 132 are substantially adjacent to each other when viewed along a side view of the optical power divider 102.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise forms disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

What is claimed is:

1. An optical power divider comprising:
a body having a first side and a second side;
said first side having at least one cylindrical input lens; and
said second side having an array of output lenses,
wherein the at least one cylindrical input lens is configured to expand input light along a first axis to be directed to a plurality of the output lenses arranged along the first axis and wherein the output lenses are configured to focus the light received from the input lenses into respective output beams of light.

2. The optical power divider according to claim 1, wherein the at least one cylindrical input lens is further configured to expand the input light along the first axis only.

3. The optical power divider according to claim 1, wherein the cross section of the cylindrical input lens is defined by a hyperbola.

4. The optical power divider according to claim 1, wherein the body comprises a plurality of cylindrical input lenses, and wherein the body comprises a smaller number of cylindrical input lenses as compared with a number of the output lenses.

5. The optical power divider according to claim 1, wherein the output lenses comprise spherical surfaces.

6. The optical power divider according to claim 1, wherein the output lenses comprise aspheric surfaces designed such that a point outside of the corresponding input cylindrical lens is imaged to a corresponding point outside of the aspheric output lenses.

7. The optical power divider according to claim 1, wherein the output lenses are sized to substantially equalize the optical power sent through each of the output lenses.

8. The optical power divider according to claim 1, wherein the cylindrical input lenses and the output lenses are integrally formed with the body.

9. The optical power divider according to claim 1, wherein the cylindrical input lenses and the output lenses are molded into the body.

10. The optical power divider according to claim 1, wherein the body is formed of at least one of a plastic and a glass material.

11. A system for communicating data through light beams among electronic devices, said system comprising:
an optical power divider formed of a body having a first side and a second side, said first side having at least one cylindrical input lens and said second side having an array of output lenses arranged along a first axis;
at least one light beam source, said at least one light beam source being configured to input at least one light beam into the at least one cylindrical input lens, wherein the at least one cylindrical input lens is configured to expand the at least one light beam along the first axis to be directed to a plurality of the output lenses and wherein the output lenses are configured to focus the light received from the input lenses into respective beams of light; and
a plurality of light beam collectors configured to receive the beams of light outputted from the output lenses.

12. The system according to claim 11, wherein the at least one light beam source comprises at least one of a multi-mode fiber, a vertical-cavity surface-emitting laser, a hollow waveguide, and an optical waveguide.

13. The system according to claim 11, wherein the light beam collectors comprise at least one of multimode fibers, hollow waveguides, and optical waveguides.

14. The system according to claim 11, wherein the at least one light beam source is connected to a source electronic device and wherein each of the light beam collectors is connected to a separate sink electronic device.

15. The system according to claim 11, wherein the optical power divider functions as a star coupler between the electronic devices.

16. The system according to claim 11, wherein the output lenses comprise spherical surfaces.

17. The system according to claim 11, wherein the output lenses comprise aspheric surfaces designed such that a point outside of the corresponding input cylindrical lens is imaged to a corresponding point outside of the aspheric output lenses.

18. The system according to claim 11, wherein the at least one cylindrical input lens and the output lenses are integrally formed with the body of the optical power divider.

19. The system according to claim 12, wherein the body of the optical power divider comprises a plastic material and wherein the at least one cylindrical input lens and the output lenses are molded into the body.

20. An optical power divider comprising:
a body having a first side and a second side;
said first side having a first cylindrical input lens and a second cylindrical input lens, wherein the first cylindrical input lens is configured to receive a first input light beam and to expand the first input light beam along a single axis only and the second cylindrical input lens is configured to receive a second input light beam and to expand the second input light beam along a separate single axis only; and
said second side having a first group of output lenses and a second group of output lenses, wherein the first group of the output lenses is arranged to receive the first expanded light beam from the first cylindrical input lens along the single axis and wherein the second group of the output lenses is arranged to receive the second expanded light beam from the second cylindrical input lens along the separate single axis, wherein the first group and the second group of output lenses are configured to focus the received light beams into respective output beams of light, and wherein each of the output lenses comprises at least one of spherical and aspheric surfaces.
